(19) United States
(12) Patent Application Publication
(10) Pub. No.: US 2026/0055849 A1
(43) Pub. Date: Feb. 26, 2026

(54) A PROCESS FOR THE EXPLOSION-PROOF STORAGE OF NITROUS OXIDE

(71) Applicant: BASF SE, Ludwigshafen am Rhein (DE)

(72) Inventors: Joaquim Henrique TELES, Ludwigshafen am Rhein (DE); Anton MEIER, Ludwigshafen am Rhein (DE); Christian MUELLER, Ludwigshafen am Rhein (DE); Markus GOEDDE, Ludwigshafen am Rhein (DE); Michael SCHELPER, Ludwigshafen am Rhein (DE)

(21) Appl. No.: 19/102,554

(22) PCT Filed: Jul. 31, 2023
(86) PCT No.: PCT/EP2023/071124

§ 371 Date: Feb. 10, 2025

(30) Foreign Application Priority Data
Aug. 11, 2022 (EP) 22189914.9

(51) Int. Cl. F17C 5/02

(52) U.S. Cl. CPC F17C 5/02; F17C 2201/054; F17C 2221/03; F17C 2223/0153; F17C 2260/042; F17C 2265/025

(57) ABSTRACT

A process for the explosion-proof storage of nitrous oxide in the liquid phase in a container comprising filling the container with nitrous oxide and an inert component selected from nitrogen, oxygen, carbon dioxide, water, argon, helium, krypton, xenon and mixtures thereof, and keeping it at a temperature of 190 to 273 K, wherein (i) the container has in all three spatial directions an inner distance between two opposite interior walls of ≥10 cm, (ii) the concentration of the inert components comprises 2 to 20 wt.-% in total, based on the nitrous oxide in the liquid phase, and (iii) compounds selected from—gases having a flammable range with air at 293.15 K and 101.3 kPa abs,—liquids having a flash point of ≤366.15 K at 101.3 kPa abs, and—mixtures thereof are kept at 0 to 2 wt.-% in total, based on the nitrous oxide in the liquid phase.

The present invention relates to a process for the explosion-proof storage of nitrous oxide in a container in which the nitrous oxide is kept together with an inert gas at 190 to 273 K in the liquid phase.

Nitrous oxide, chemically N₂O and commonly known as laughing gas, is a versatile chemical compound used for diverse applications. It is mainly used for medical purposes, especially in surgery and dentistry due to its anesthetic and pain reducing properties, in food technology as a propellant due to its good fat solubility e.g. as for foaming cream, as well as an oxidant, e.g. in rocket motors or vehicles to increase the engine performance, as an oxidizing agent in electronics industry for the production of thin oxide films, or even in chemical synthesis plants instead of oxygen as a gentle oxidizing agent, such as for the selective oxidation of olefins directly in one step to ketones.

Depending on its intended use, nitrous oxide is commercially offered in different purities and containers of different sizes. So called cream chargers for home use are typically small metal bottles with an outer diameter of around 2 cm in which nitrous oxide is present as compressed gas. Nitrous oxide for industrial uses is typically offered in gas cylinders with sizes of 2, 5, 10 or 50 L or even in large containers like standard ISO tank containers, which usually hold between 17.5 and 26.0 m³ or even higher. Therein, the nitrous oxide is usually present in liquid form with a typical purity in the range of 99% (relating to purity grade 2.0) to 99.999% (relating to purity grade 5.0). Nitrous oxide for medical use is typically distributed in 10 L gas cylinders either in a purity of 98% or as a 50%/50% mixture with oxygen.

Nitrous oxide can easily be produced in commercial scale by thermal decomposition of ammonium nitrate. U.S. Pat. No. 3,656,899 describes such a process, in which ammonium nitrate is heated in an aqueous solution of nitric acid containing chloride ions to a temperature of 100 to 160° C. while maintaining an ammoniacal atmosphere above the solution. The ammoniacal atmosphere neutralizes acidic vapors in the nitrous oxide containing gas phase. The nitrous oxide containing gas phase is then guided to a scrubbing column in which water vapors and the surplus of ammonia is washed out, and crude gaseous nitrous oxide obtained in purity of around 98 wt.-%, which can subsequently be further purified.

Furthermore, nitrous oxide can also be prepared in commercial scale by catalytic oxidation of ammonia. WO 98/25,698 describes such a process using multi metal oxide catalysts containing MnO₂, Bi₂O₃ and Al₂O₃ over which a gaseous mixture containing ammonia and oxygen is passed at around 300 to 350° C. After removal of water and non-converted ammonia, a crude product stream containing 79.6 to 84.9% nitrous oxide beside nitrogen oxide and oxygen is obtained.

A further preparation method for nitrous oxide is its recovery from a nitrous oxide containing off-gas as it is, for example, produced by the catalytic oxidation of ammonia to nitric acid, or by the non-catalytic oxidation of cyclohexanol/cyclohexanone with nitric acid to adipic acid.

U.S. Pat. No. 4,177,645 describes the isolation of a nitrous oxide enriched stream from a nitrous oxide containing off-gas stream by compressing it to a pressure of 15 to 300 bar, stepwise cooling it in a cascade of heat exchangers connected in series to a temperature of down to −88° C. (185.15 K) to condensate a nitrous oxide enriched liquid, guiding the condensed liquid through a collecting vessel and expanding it into a distillation column, in which the nitrous oxide is freed from oxygen and nitrogen. The examples illustrate the purification of defined amounts of 78 to 100 kg nitrous oxide containing off-gas streams to obtain either pure nitrous oxide (example 1) or nitrous oxide with 1.7 wt.-% nitrogen oxides and 5 wt.-% carbon dioxide (example 3).

U.S. Pat. No. 8,449,655 discloses the isolation of a nitrous oxide enriched stream from a nitrous oxide containing off-gas stream by a dual absorption/desorption process in which in the first stage, the off-gas is absorbed in a water-based solvent having a pH value of 3.5 to 8.0 and subsequently desorbed to release a nitrous oxide enriched gas mixture, which is then in a second stage absorbed in a further water-based solvent having a pH value of 2.0 to 8.0 and subsequently desorbed to release a gas mixture more enriched with nitrous oxide. The purified gas stream obtained in this way is mentioned to preferably contain 50 to even up to 99.0 wt.-% of nitrous oxide together with carbon dioxide, oxygen, nitrogen or nitrogen oxides as further components. For removing traces of water, U.S. Pat. No. 8,449,655 proposes to compress the purified gas stream to 1 to 35 bar and to cool it down to 1 to 25° C. (274.15 to 298.15 K). Furthermore, it is mentioned that the obtained gas stream can also be liquified by compressing and cooling it to a temperature of down to −70° C. (203.15 K), and that such a liquified gas mixture can be used directly in an oxidation process in which nitrous oxide acts as an oxidant. According to the examples, the two desorption towers are operated at a temperature of 35° C. (308.15 K) and thus the purified gas stream obtained at this temperature with a nitrous oxide content in the range of 54.9 wt.-% (example 1) up to 81.5 wt.-% (example 5).

U.S. Pat. No. 8,808,430 discloses the isolation of a nitrous oxide enriched stream from a nitrous oxide containing off-gas stream by an absorption/desorption process and subsequent condensation of the nitrous oxide enriched desorption stream. The obtained nitrous oxide enriched gas stream is mentioned to preferably contain 50 to even up to 99.0 wt.-% of nitrous oxide together with carbon dioxide, oxygen, nitrogen or nitrogen oxides as further components. The condensation is described to be preferable performed at a pressure of 1 to 35 bar and a temperature of 10° C. (283.15 K) down to −70° C. (203.15 K). According to example 1, nitrous oxide of an off-gas from a nitric acid plant was concentrated by an absorption/desorption process, and the concentrated stream liquified at −12° C. (261.15 K) in an upright tube bundle heat exchanger operated with a water/glycol coolant to a liquid stream containing 87.9 vol.-% nitrous oxide, 11.4 vol.-% carbon dioxide, 0.3 vol.-% water, 0.3 vol.-% nitrogen and 0.14 vol.-% oxygen. The obtained stream was then subsequently purified in a stripping column containing a structured metal packing and being operated with a countercurrent stream of nitrogen, and a liquid stream containing 86.7 vol.-% nitrous oxide, 11.1 vol.-% carbon dioxide, 1.9 vol.-% nitrogen and 0.01 vol.-% oxygen obtained.

The three above-mentioned patents U.S. Pat. Nos. 4,177,645, 8,449,655 and 8,808,430 relate to the isolation of a nitrous oxide enriched stream from a nitrous oxide containing off-gas stream, in which the nitrous oxide enriched stream is, according to U.S. Pat. No. 4,177,645 a stream containing 90 to 99 wt.-% or even pure nitrous oxide, and according to U.S. Pat. Nos. 8,449,655 and 8,808,430 a stream containing 50 to 99.0 wt.-% of nitrous oxide, and which has been liquified by cooling to a temperature of up to −88° C. (185.15 K) according to U.S. Pat. No. 4,177,645, and up to −70° C. (203.15 K) according to U.S. Pat. Nos. 8,449,655 and 8,808,430. All three patents are silent on safety issues regarding the handling of liquified nitrous oxide, although there is at least one nitrous oxide induced explosion accident described in the state of the art.

This nitrous oxide induced explosion accident is described and discussed by A. Lange, and was published in “Zeitschrift für angewandte Chemie” 29 (1902) 725-731. According to this essay, a factory worker was busy in August 1900 filling several small bottles with 850 g nitrous oxide each from a storage bottle filled with initially 17 kg liquid nitrous oxide. The storage bottle was fixed upside down, connected via a flexible copper pipe between the valve of the storage bottle and the valve of the small bottle, and the storage bottle was smoothly heated with an open flame. After the filling of the 14^{th} small bottle and the closing of the two valves, the storage bottle exploded violently for no apparent reason, killing the factory worker. In the long-winded discussion, A. Lange excluded a defect in material as well as a too high pressure in the storage bottle due to the smooth heating and assumed at the end a chemical explosion since nitrous oxide is an endothermic and endergonic compound. The chemical explosion was assumed to be either induced by a sudden initiation, e.g. by an additional energy input such as by the friction at the closing of the valve, or caused by impurities which suddenly sparked a catalytically induced, spontaneous decomposition as the required temperature was reached by the heating under the open flame. As a conclusion, A. Lange teaches to avoid temperatures above 40° C. and to install a safety valve which automatically opens if the pressure accidentally raises.

In the context of the present invention, however, it was surprisingly recognized that even in absence of catalytically acting impurities and direct ignition sources, liquid nitrous oxide is even at a temperature of less than 40° C. not generally explosion proof.

It was an object of the present invention to find a process for the explosion-proof handling of liquid nitrous oxide in industrial scale such as during its production and purification or for its storage whether for its subsequent filling into gas cylinders or bottles, its use in chemical plants for the selective oxidation of organic compounds, or for any other applications. The process shall be easy to perform, preferably using standard equipment or only slightly adapted equipment.

We have surprisingly found a process for the explosion-proof storage of nitrous oxide in the liquid phase in a container comprising filling the container with nitrous oxide and an inert component selected from nitrogen, oxygen, carbon dioxide, water, argon, helium, krypton, xenon and mixtures thereof, and keeping it at a temperature of 190 to 273 K, in which
(i) the container has in all three spatial directions an inner distance between two opposite interior walls of ≥10 cm,
(ii) the concentration of the inert components comprises 2 to 20 wt.-% in total, based on the nitrous oxide in the liquid phase, and
(iii) compounds selected from
   gases having a flammable range with air at 293.15 K and 101.3 kPa abs,
   liquids having a flash point of ≤366.15 K at 101.3 kPa abs, and
   mixtures thereof
   are kept at 0 to 2 wt.-% in total, based on the nitrous oxide in the liquid phase.

Even if it is basically possible to store gases such as nitrous oxide explosion-proof also in gaseous form as a pressurized gas, the present invention is deliberately directed to the storage in the liquid phase, since the liquid phase has the great advantage of a much higher density and thus significantly more gas per unit volume can be stored. According to the phase diagram of nitrous oxide, liquid nitrous oxide can principally be present at a temperature between the critical point (36.42° C. (309.57 K) and 7.245 MPa abs) and the triple point (−90.82° C. (182.33 K) and 0.08785 MPa abs) and a pressure above the gas/liquid curve but below the liquid/solid curve. As it can easily be derived from the above-mentioned values, liquid nitrous oxide requires at a temperature just below the temperature of the critical point a pressure of more than 7.2 MPa abs to stay liquid, whereas at a temperature slightly above the temperature of the triple point, a low pressure of 0.088 MPa abs already suffices. The lower the temperature of the liquid nitrous oxide, the lower the pressure required to keep the nitrous oxide liquid. Low pressures are advantageous in several aspects, because, for example, less compression energy is required and the design of the storage system regarding the material requirements and safety issues becomes easier. According to the teaching of A. Lange in the above-mentioned journal “Zeitschrift für angewandte Chemie” 29 (1902) 725-731, the handling of liquid nitrous oxide below 40° C. in connection with a safety valve is recommended to minimize or even avoid the risk of a sudden and unforeseen explosion. The document implies that the risk of explosion continues to decrease as the temperature further drops. Thus, the risk of explosion of liquid nitrous oxide at a temperature of only −0.15° C. (273 K) and below was initially expected to be very low or even completely non-existent.

Contrary to all expectations, deep investigations in the course of the invention turned out that despite a low temperature of ≤273 K (≤−0.15° C.) or more precisely because of this, liquid nitrous oxide is still sensitive to explosion if it is handled in a container in which the inner distance between two opposite interior walls is in all three special directions well above 5 cm. However, such containers are particularly relevant for the storage of technically relevant amounts of liquid nitrous oxide.

It was then surprisingly found that even at a temperature of 190 K (−83.15° C.) to 273 K (−0.15° C.) nitrous oxide can still be stored explosion-proof in liquid form in technically relevant amounts in a container
(i) which has in all three spatial directions an inner distance between two opposite interior walls of ≥10 cm, if
(ii) it additionally contains an inert component selected from nitrogen, oxygen, carbon dioxide, water, argon, helium, krypton, xenon, and mixtures thereof, and such inert components comprises 2 to 20 wt.-% in total, based on the nitrous oxide in the liquid phase, and
(iii) compounds selected from
   gases having a flammable range with air at 293.15 K (20° C.) and 101.3 kPa abs,
   liquids having a flash point of ≤366.15 K (≤93° C.) at 101.3 kPa abs, and
   mixtures thereof
   are kept at 0 to 2 wt.-% in total, based on the nitrous oxide in the liquid phase.

For convenience, the temperature is sometimes given in two different units, namely in K and in° C., whereas one unit is given in brackets, as for example shown above. For the conversion of both units the following equation applies: T[K]=T[° C.]+273.15. In the event of discrepancies, the value mentioned without brackets shall prevail.

The invention is explained below in more detail.

The container to be used according to the invention
(i) has in all three spatial directions an inner distance between two opposite interior walls of ≥10 cm, and
is for practical and safety reasons advantageously
   chemically inert towards liquid nitrous oxide and possible further compounds contained in the liquid phase to which the inner walls are exposed to at the temperature and pressure expected to be applied during the storage, and
   mechanically stable at the temperature and pressure expected to be applied during the storage.

Therefore, the container preferably contains a shell made of steel of appropriate thickness to achieve the required mechanical stability. As examples of suitable types of steel austenitic steels such as 1.4306, 1.4401, 1.4436, 1.4404, 1.4435, 1.4432, 1.4541 and 1.4571 are mentioned. The container may contain an in-liner, for example an inner jacket of an inert material or may be coated with an inert material on the interior. Depending on the material of the container and the temperature and pressure expected to be applied during the storage, the geometric shape of the container as well as its wall thickness typically varies from a few millimeters to a few centimeters.

The container to be used according to the invention can principally have any geometric shape and size but with the characteristic that it has in all three spatial directions an inner distance between two opposite interior walls of ≥10 cm. However, in terms of the pressure stability, the container advantageously has rounded walls, at least mainly. As appropriate shapes, cylinders with flat or preferably curved cover surfaces, spheres and three-dimensional ovals are mentioned as examples. For filling and emptying, the container has at least one connection branch or facility, whereby at least two separate connection branches or facilities are preferred as they provide more flexibility.

As already mentioned above, the container to be used according to the invention has in all three spatial directions an inner distance between two opposite interior walls of ≥10 cm. This means in other words that there is at least one point in the container from which none of the interior walls is less than 5 cm away. Preferably, the container has in all three spatial directions an inner distance between two opposite interior walls of ≥12 cm, more preferably ≥15 cm, particularly preferably ≥18 cm, very particularly preferably ≥21 cm, and most preferably ≥25 cm, preferably ≤500 cm, more preferably ≤400 cm and particularly preferably ≤350 cm.

Typically, the container used for the process of the invention has an inner volume of 8 L to 250 m³, preferably ≥15 L, more preferably ≥25 L, particularly preferably ≥55 L, very particularly preferably ≥105 L and most preferably ≥500 L, and preferably ≤200 m³, more preferably ≤100 m³, particularly preferably ≤75 m³ and very particularly preferably ≤50 m³.

In the process of the invention, the container is filled with nitrous oxide and an inert component selected from nitrogen, oxygen, carbon dioxide, water, argon, helium, krypton, xenon and mixtures thereof in a concentration of 2 to 15 wt.-% in total, based on the nitrous oxide in the liquid phase. Filling means the feeding of the mentioned components nitrous oxide and an inert component or inert components, as the case may be, to the container, irrespective of the liquid level in the container. Basically, the container can be only filled to a very low liquid level as well as up to a very liquid level, whereas for safety reasons it is recommended to preferably keep the filling level at ≤99.9 vol.-%, more preferably at ≤99.5 vol.-%, particularly preferably at ≤99 vol.-% and very particularly preferably at ≤98 vol.-%.

Although it is principally possible to feed nitrous oxide and the inert components separately and consecutively, it is preferred to feed nitrous oxide and the inert component(s) simultaneously, or alternatively consecutively but then at least in a manner that the concentration of the inert component(s) does not undercut the lower limit of 2 wt.-% in total, based on the nitrous oxide in the liquid phase, if the temperature of the liquid phase in the container is below 273 K.

As already mentioned above,
(ii) the concentration of the inert components in the process of the invention and based on the nitrous oxide in the liquid phase is 2 to 20 wt.-% in total.

It is preferably ≥2.1 wt.-%, more preferably ≥2.2 wt.-%, particularly preferably ≥2.3 wt.-%, very particularly preferably ≥2.5 wt.-% and most preferably ≥3 wt.-%, and preferably ≤18 wt.-%, more preferably ≤15 wt.-%, particularly preferably ≤13 wt.-%, very particularly preferably ≤11 wt.-% and most preferably ≤10 wt.-%. In terms of specific ranges, the concentration of the inert components comprises preferably 2.1 to 15 wt.-% and more preferably 2.1 to 10 wt.-%.

As inert components, nitrogen, oxygen, carbon dioxide, water, argon, helium, krypton, xenon and mixtures thereof are mentioned. The liquid phase may contain only one specific inert component or a mixture of two or more of different inert components. However, the plural form “inert components” used for linguistic simplification shall also embrace the presence of only one inert component, unless the circumstances clearly indicate that specifically a mixture of two or more inert components is meant. Furthermore, it is clarified that the term water in the listing generally means H₂O as chemical compound.

Generally, the inert components may be specifically added to the nitrous oxide, e.g. before or at the filling of the container, be already present in the nitrous oxide to be stored, e.g. through its preparation or its recovery from nitrous oxide containing sources, or be already present in the container when the nitrous oxide is filled in.

Although all the listed inert components have an explosion-suppressing effect, nitrogen, carbon dioxide and mixtures thereof are preferred for practical reasons as they are often typical by-products in the production of nitrous oxide, or accompanying compounds in processes where nitrous oxide is formed as a by-product. Moreover, nitrogen and carbon dioxide are easily available in large quantities.

Based on solubility data of the mentioned inert gases regarding their solubility in liquid nitrous oxide at different temperatures and pressures, which the person skilled in the art can determine by its own or look up in the relevant literature or data bases, the person skilled in the art can easily estimate how much of the respective inert gas or inert gases is/are required at a specific pressure and temperature to reach the desired concentration in the liquid phase.

Based on the concentration of the inert components and possible other compounds in the liquid phase, the concentration of nitrous oxide is generally 82 to 98 wt.-% based on the liquid phase. It is preferably ≥83.3 wt.-%, more preferably ≥85.5 wt.-%, particularly preferably ≥87.0 wt.-%, very particularly preferably ≥88.5 wt.-% and most preferably ≥89.3 wt.-%, and preferably ≤97.9 wt.-%, more preferably ≤97.8 wt.-%, particularly preferably ≤97.6 wt.-%, very particularly preferably ≤97.6 wt.-% and most preferably ≤97.1 wt.-%.

The concentrations of nitrous oxide, of the inert compounds as well as of possible other compounds in the liquid phase of the container can easily be determined by taking a sample of the liquid phase and analyzing it, for example by gas chromatography. The person skilled in the art knows how to perform such analytical measurement and how to evaluate the results quantitatively.

Although it was found that a certain minimum concentration of inert components in the liquid phase is necessary to suppress a sudden explosion of nitrous oxide at 190 to 273 K in a container having an inner distance between two opposite interior walls in all three spatial directions of ≥10 cm, it turned out that this is not yet sufficient to actually avoid such a sudden explosion and that a certain concentration of further compounds, which can superficially be described as easily flammable compounds, still lead to a latent explosive mixture. Therefore, the composition of the liquid phase to be stored according to the invention is further specified by an upper limit of the range of such possible further compounds. More specifically, and as already mentioned above, these further compounds
(iii) are selected from
   gases having a flammable range with air at 293.15 K (20° C.) and 101.3 kPa abs,
   liquids having a flash point of ≤366.15 K (≤93° C.) at 101.3 kPa abs, and
   mixtures thereof, and
   are to be kept at 0 to 2 wt.-% in total, based on the nitrous oxide in the liquid phase.

In the context of the present invention, gases are defined as compounds that are gaseous at a pressure of 101.3 kPa abs and a temperature of 293.15 K. Accordingly, liquids are compounds that are liquid at a pressure of 101.3 kPa abs and a temperature of 293.15 K.

Gases having a flammable range with air at 293.15 K and 101.3 kPa abs are in the following simply referred to as “flammable gases”. The attribute of whether a gas is a flammable gas or not, can, for example, easily be experimentally determined by the experimental method described in DIN EN ISO 10156:2017 named “Determination of fire potential and oxidizing ability for the selection of cylinder valve outlets”. This DIN EN ISO method is inter alia cited in the “Globally Harmonized System of classification and labeling of chemicals (GHS)”, 9th revised edition, United Nations, New York and Geneva, 2021, Chapter 2.2, in which the criteria for the categorization of flammable gases into the GHS categories 1A (extremely flammable gas, GHS pictogram), 1B (flammable gas, GHS pictogram) and 2 (flammable gas, no GHS pictogram) are specified. In DIN EN ISO 10156:2017, two experimental methods are described. The first method relates to the determination whether the respective gas is flammable at all, and the second method relates to the determination of the flammability limit. For determining whether a respective gas has a flammable range with air at 293.15° C. and 101.3 kPa abs as specified for the process of the invention, the first method suffices as the flammability limit is not relevant.

The determination works in such a way that mixtures with different increasing concentrations of the respective gas in air are successively fed into an upright cylinder of thick glass having a diameter of >50 mm and a height of ≥300 mm, and once at a pressure of 101.3 kPa abs the measuring temperature of 293.15 K has been reached, sparks are generated by an high voltage spark generator. If a flame detachment and an upwards propagation of ≥100 mm is observed, the respective gas is classified as flammable. The person skilled in the art knows how to perform such a determination.

As examples of flammable gases hydrogen, carbon monoxide, ammonia, methylamine, dimethylamine, trimethylamine, ethylamine, methane, ethane, propane, n-butane, 2-methylpropane, 2,2-dimethylpropane, ethene, propene, but-1-ene, but-2-ene, 2-methylprop-1-ene, acetylene, methylacetylene, 1-butine, chloromethane, bromomethane, chloroethane, vinyl chloride, dimethyl ether, methyl ethyl ether, methyl vinyl ether, formaldehyde, hydrogen sulfide, methyl mercaptan, phosphine, methyl phosphine, diborane and stibine are mentioned.

Liquids having a flash point of ≤366.15 K at 101.3 kPa abs are in the following simply referred to as “flammable liquids”. The attribute of whether a liquid is a flammable liquid or not, can, for example, easily be experimentally determined by the experimental method described in ASTM D 3828-07a named “Standard test method for flash point by small scale closed cup tester”. This ASTM method is cited in the “Globally Harmonized System of classification and labeling of chemicals (GHS)”, 9th revised edition, United Nations, New York and Geneva, 2021, Chapter 2.6, in which the criteria for the categorization of flammable liquids into the GHS categories category 1 (extremely flammable liquid and vapor, GHS pictogram), category 2 (highly flammable liquid and vapor, GHS pictogram), category 3 (flammable liquid and vapor, GHS pictogram) and category 4 (combustible liquid, no GHS pictogram) are specified. In ASTM D 3828-07a, two experimental methods are described. The first method concerns the determination of whether the respective liquid has a flash point of ≤366.15 K at 101.3 kPa abs at all, and the second method concerns the determination of the temperature of the flash point. For determining whether the respective liquid has a flash point of ≤366.15 K at 101.3 kPa abs at all, the first method suffices as the actual flash point is not required for this finding.

In principle, the determination works in such a way that the test compound is filled into a so-called cup unit and tried to ignite at 101.3 kPa abs with a test flame once the intended measuring temperature has been reached. The cup unit can be roughly described as a heatable and coolable metal block of cylindrical shape made of an aluminum alloy, having a block diameter of around 62 mm, a cylindrical depression at the top with a diameter of around 49.55 mm and a depth of around 9.85 mm, a lid over the cylindrical depression with a sealable filling orifice and a further opening of around 95 mm² with a shutter mechanism, and a test flame jet above the shutter opening. At the beginning of the measurement, the cup unit is brought to the desired test temperature by heating or cooling, and a small amount of 2 mL of the respective liquid filled into the cylindrical depression through the filling orifice, e.g. via a syringe, and the orifice sealed afterwards. As next step, a test flame at a test flame jet mounted above the further opening with the mentioned shutter mechanism, which is closed by default, is ignited. Then, the shutter is shortly opened for approximately 2.5 seconds and the behavior of the system observed. If during the short opening a large flame appeared and instantaneously propagated itself over the surface, the liquid is deemed to have flashed. The person skilled in the art knows how to perform such a determination.

As examples of flammable liquids
methyl ethyl amine, diethylamine, triethylamine, n-propylamine, di-n-propylamine, tri-n-propylamine, n-butylamine, di-n-butylamine, tri-n-butylamine, ethylenediamine, pyrrolidine, piperidine and further alkyl amines, alkylene diamines and heterocyclic aliphatic amines having a flash point of ≤366.15 K at 101.3 kPa abs,
n-pentane, 2-methylbutane, n-hexane, n-heptane, n-octane, n-nonane, n-decane, n-undecane, n-dodecane, cyclopentane, cyclohexane and further saturated alkanes and saturated cycloalkanes having a flash point of ≤366.15 K at 101.3 kPa abs,
1,3-butadiene, 2-butine, 1-pentene, 2-pentene, 2-methylbut-1-ene, 2-methylbut-2-ene, 2-methyl-1,3-butadiene, 1-octene, cyclopentene, cyclopentadiene, cyclohexene, 1,4-cyclohexadiene and further unsaturated alkanes and unsaturated cycloalkanes having a flash point of ≤366.15 K at 101.3 kPa abs,
benzene, toluene, xylenes, ethylbenzene, furan, pyrrol and further aromatic compounds having a flash point of ≤366.15 K at 101.3 kPa abs,
1-chloropropane, 2-chloropropane, 1-chlorobutane, 2-chlorobutane, chlorobenzene and further halogenated hydrocarbons having a flash point of ≤366.15 K at 101.3 kPa abs,
ethanol, 1-propanol, 2-propanol, 1-butanol, 2-butanol, 2-methyl-1-propanol, tert.-butanol, pentanols and further alcohols having a flash point of ≤366.15 K at 101.3 kPa abs,
diethyl ether, 2,3-dihydrofuran, 2,5-dihydrofuran, tetrahydrofuran and further saturated or unsaturated alkyl ethers and saturated or unsaturated cycloalkyl ethers having a flash point of ≤366.15 K at 101.3 kPa abs,
acetaldehyde, propionaldehyde, butyraldehyde, valeraldehyde, acetone, 2-butanone, 2-pentanone, 3-pentanone, crotonaldehyde and further saturated or unsaturated aldehydes and saturated or unsaturated ketones having a flash point of ≤366.15 K at 101.3 kPa abs,
methyl formate, ethyl formate, propyl formate, methyl acetate, ethyl acetate, propyl acetate, methyl propionate and further saturated or unsaturated alkyl esters having a flash point of ≤366.15 K at 101.3 kPa abs
   are mentioned.

As already mentioned above, the concentration of flammable gases and liquids are to be kept at 0 to 2 wt.-% in total, based on the nitrous oxide in the liquid phase. “In total” means that the total concentration of all flammable gases and liquids together and present in the liquid phase is within the specified range. Furthermore, “0 to 2 wt.-%” means that the concentration of all flammable gases and liquids present in the liquid phase can even be 0 wt.-%, which is equivalent to the absence of flammable gases and liquids.

The compounds selected from
gases having a flammable range with air at 293.15 K and 101.3 kPa abs,
liquids having a flash point of ≤366.15 K at 101.3 kPa abs, and
mixtures thereof
are preferably kept in total at 0 to 1.8 wt.-%, more preferably at 0 to 1.5 wt.-%, particularly preferably at 0 to 1 wt.-%, very particularly preferably at 0 to 0.5 wt.-%, most preferably at 0 to 0.2 wt.-% and notably at 0 to 0.1 wt.-%, based on the nitrous oxide in the liquid phase.

The concentrations of possible flammable gases and liquids present in the liquid phase of the container can easily be determined by taking a sample of the liquid phase and analyzing it, for example, by gas chromatography. The person skilled in the art knows how to perform such analytical measurement and how to evaluate the results quantitatively.

The phrase that flammable gases and liquids “are kept” at a certain concentration level simply means that the nitrous oxide and the inert components filled into the container as well as possible compounds already present in the container contain, at the maximum, an amount of flammable gases and liquids which causes a total concentration of flammable gases and liquids in the liquid phase within the specified range, including the absence of any flammable gases and liquids, and that no or only such an amount of flammable gases and liquids is further added at the maximum to the container that ensures the compliance with the specified range. Preferably, no flammable gases and liquids are additionally added to the container and the amount of flammable gases and liquids present in the container, it any, is based on the amount brought into by the filling with the nitrous oxide and the inert components.

Another class of compounds which shall preferably be limited in their concentration or even avoided are nitrogen oxides having a N to O ratio of ≤1 as they are oxidizing gases, and in combination with water also corrosive, so that the chemical quality of nitrous oxide would be negatively influenced by them. This applies to a very wide range of possible applications, such as its use for medical purposes, in food technology, as an oxidizing agent in electronics industry, as an oxidant in rocket motors or as gentle oxidizing agent. Therefore, the nitrous oxide to be stored according to the invention preferably contains no or only a limited amount of such nitrogen oxides. More precisely, nitrogen oxides having a N to O ratio of ≤1 are preferably kept at a concentration at which the amount of nitrogen present in these nitrogen oxides is 0 to 1000 wt.-ppm in total, based on the nitrous oxide in the liquid phase. “0 to 1000 wt.-ppm” means that the concentration of nitrogen bound in these nitrogen oxides present in the liquid phase can even be 0 wt.-%, which is equivalent to the absence of such nitrogen oxides. Regarding the phrase “are kept”, the already for the flammable gases and liquids described explanation applies mutatis mutandis.

Specifically, nitrogen oxides having a N to O ratio of ≤1 are nitrogen monoxide (NO) having a N/O-ratio of 1, dinitrogen trioxide (N₂O₃) and trinitramide (N₄O₆) having a N/O-ratio of 0.67, nitrogen dioxide (NO₂) and dinitrogen tetroxide (N₂O₄) having a N/O-ratio of 0.5 and dinitrogen pentoxide (N₂O₅) having a N/O-ratio of 0.4. More preferably, nitrogen monoxide and nitrogen dioxide are kept at a concentration at which the amount of nitrogen present in these nitrogen oxides is 0 to 1000 wt.-ppm in total, based on the nitrous oxide in the liquid phase.

Nitrogen oxides having a N to O ratio of ≤1 are preferably kept at a concentration at which the amount of nitrogen present in these nitrogen oxides is 0 to 1000 wt.-ppm in total, more preferably 0 to 100 wt.-ppm, particularly preferably 0 to 10 wt.-ppm, very particularly preferably at 0 to 5 wt.-ppm, most preferably at 0 to 2 wt.-ppm and notably at 0 to 1 wt.-ppm, based on the nitrous oxide in the liquid phase.

Nitrogen oxides having a N to O ratio of ≤1 can, for example, easily be quantitatively determined by taking a defined amount of the liquid phase, transferring it into standard conditions regarding temperature and pressure so that the sample is transferred into the gaseous phase, and adding a sufficient amount of an aqueous solution of hydrogen peroxide to the gas phase. All nitrogen oxides having a N to O ratio of ≤1 react with hydrogen peroxide to form nitric acid (HNO₃), whereas nitrous oxide does not react with hydrogen peroxide. The formed nitric acid can then easily be quantitatively determined, for example by ion chromatography. The person skilled in the art knows how to perform such analytical measurement and how to evaluate the results quantitatively.

Although the process of the invention is generally applicable at a broad temperature range of 190 to 273 K, there are two opposing effects. One effect relates to the temperature dependency of the pressure. The lower the storage temperature, the lower the pressure inside the container, the lower the evaporation rate in case of a leak, the easier the operation of the pressure pump because the temperature is further away from the critical point, and, as already explained above, the lower the energy required for compression. The other effect concerns the material property of the container, which generally becomes increasingly advantageous with increasing temperature because materials generally tend to become brittle at very low temperatures.

Therefore, the liquid phase in the container is preferably kept at ≥200 K, more preferably at ≥213 K, particularly preferably at ≥223 K and very particularly preferably at ≥233 K, and preferably at ≤268 K, more preferably at ≤263 K, particularly preferably at ≤258 K and very particularly preferably at ≤253 K.

The cooling can, for example, easily be performed by a cooling medium which circulates through cooling spirals, and which are located in the container or wrapped around the container. Depending on the intended temperature, suitable cooling media can, for example, be ethylene glycol/water mixtures, liquid ammonia or other suitable cooling media known in the state of the art and available commercial under such tradenames as Dowtherm® or Fragoltherm®. The person skilled in the art knows how to cool down such a container.

The phrase “keeping it at a temperature of . . . ” simply means that the temperature of the nitrous oxide in the liquid phase in the container is held within the specified range, whereas the specific temperature might fluctuate over time within the specified range.

The process of the invention for the storage of nitrous oxide is detached from any time restrictions. This means that the time during which the nitrous oxide is stored in the container can be very short to very long, or, in other words, be only a few seconds up to several years. To be more specific, the storage time is generally ≥10 seconds, preferably ≥1 minute, more preferably ≥1 hour, particularly preferably ≥10 hours, very particularly preferably ≥1 day and most preferably ≥1 week. The nitrous oxide may be stored according to the invention even for a very long time such as for up to 1 year, for up to 10 years or even longer.

Storage does not require that the liquid phase containing the nitrous oxide is fixed in a closed container without any inlet of further nitrous oxide and inert components, and any outlet of nitrous oxide and inert components. So, storage in the sense of this application does embrace the keeping in a closed container as well as the keeping in a container for a while, in which further nitrous oxide and inert components are continuously or intermittently added and continuously or intermittently withdrawn.

In a general embodiment for the explosion-proof storage of nitrous oxide in the liquid phase, liquid, pre-cooled nitrous oxide, which was separated from the off-gas of an adipic acid plant, is fed together with nitrogen into a 50 m³ cylindrical storage tank with outside cooling spirals, which was previously purged with nitrogen, which has an inner distance between two opposite interior walls of 300 cm, and which is insulated and additionally provided with external cooling tubes to compensate for heat losses and to maintain a temperature of 248 K. Nitrogen is fed as a gas in a pressure-controlled manner. The pressure required to achieve the desired nitrogen concentration in the liquid phase can be determined by the solubility data of nitrogen in liquid nitrous oxide. For instance, to achieve a concentration of nitrogen in the liquid phase of around 3 wt.-% based on the nitrous oxide in the liquid phase a total pressure of 3.4 MPa abs is to be set. The nitrous oxide is stored under these conditions for two weeks and then withdrawn from the cylindrical storage tank in liquid form by using a high-pressure membrane pump.

In a second general embodiment for the explosion-proof storage of nitrous oxide in the liquid phase, liquid, pre-cooled nitrous oxide together with carbon dioxide are fed into a 32 m³ cylindrical storage tank container with outside cooling spirals, which was previously purged with nitrogen, which has an inner distance between two opposite interior walls of 235 cm, and which is insulated and additionally provided with external cooling tubes to compensate for heat losses and to maintain a temperature of 255 K. The amount of carbon dioxide was calculated to provide a carbon dioxide concentration in the liquid phase of around 10 wt.-% based on the nitrous oxide in the liquid phase together with some traces of nitrogen from the previous purging procedure. The nitrous oxide is stored under these conditions for two months and then withdrawn from the cylindrical storage tank in liquid form via a cooled pipe.

In a third general embodiment for the explosion-proof storage of nitrous oxide in the liquid phase, liquid, pre-cooled nitrous oxide from an ammonium nitrate decomposition plant is fed together with nitrogen into a 1 m³ cylindrical storage tank with outside cooling spirals, which was previously purged with argon, which has an inner distance between two opposite interior walls of 80 cm, and which is insulated and additionally provided with external cooling tubes to compensate for heat losses and to maintain a temperature of 263 K. Argon is fed as a gas in a pressure-controlled manner to cause an argon concentration in the liquid phase of around 5 wt.-%. The pressure required to achieve the desired argon concentration in the liquid phase can be determined by the solubility data of argon in liquid nitrous oxide. The nitrous oxide is stored under these conditions for 1 month and then slowly withdrawn from the cylindrical storage tank in liquid form over a period of a further month by using a high-pressure membrane pump.

In a fourth general embodiment for the explosion-proof, intermediate storage of nitrous oxide in the liquid phase, liquid, pre-cooled nitrous oxide, which was separated from the off-gas of an adipic acid plant, is continuously fed together with nitrogen into a 50 m³ cylindrical storage tank with outside cooling spirals, which was previously purged with nitrogen, which has an inner distance between two opposite interior walls of 300 cm, and which is insulated and additionally provided with external cooling tubes to compensate for heat losses and to maintain a temperature of 248 K. Nitrogen is fed as a gas in a pressure-controlled manner to cause a nitrogen concentration in the liquid phase of around 3 wt.-%. The pressure required to achieve the desired nitrogen concentration in the liquid phase can be determined by the solubility data of nitrogen in liquid nitrous oxide. The nitrous oxide is only temporarily stored under these conditions as the storage tank only acts as a buffer tank to absorb fluctuations in the filling and withdrawal. Therefore, the nitrous oxide is continuously withdrawn from the cylindrical storage tank in liquid form by using a high-pressure membrane pump and fed to a chemical plant in which it is used as a gentle oxidizing agent. Depending on the amounts filled in and withdrawn per unit of time, the average dwell time of the nitrous oxide in the storage tank differs from a few hours to a few weeks with a typical value of 15 hours.

The process of the invention enables the explosion proof handling of liquid nitrous oxide in industrial scale such as during its production and purification or for its storage whether for its subsequent filling into gas cylinders or bottles, its use in chemical plants for the selective oxidation of organic compounds, or for any other applications. It is easy to perform. Firstly, standard equipment can be easily used, provided the minimum requirement regarding the inner distance between two opposite interior walls is fulfilled, which is usually the case for typical storage containers. Secondly, the required inert gases are well known, easily accessible, easy to dose, and usually do not interfere with subsequent applications or can be selected accordingly. Thirdly, temperatures below 272 K are easily accessible by using a standard cooling medium such as a glycolic solutions or liquid ammonia.

### EXAMPLES

### Experimental Set-Up and Execution

The experimental set-up for determining the potential explosiveness of liquid nitrous oxide containing samples was based on the commonly known UN-GAP named as a test “to determining if a substance has explosion properties”, published in the “Manual of Tests and Criteria”, 7^{th} revised edition, United Nations, New York and Geneva, 2019, part I, section 11, test series 1, but with some adjustments as described in the following. The test was designed to determine the sensitivity to detonative shock of a certain substance or substance mixture.

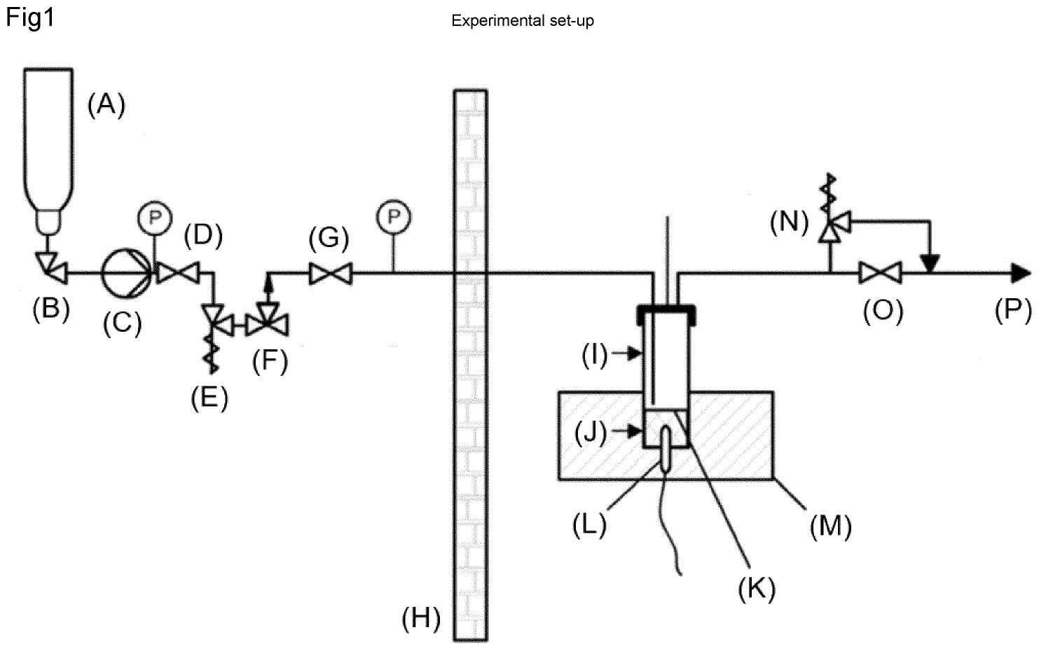

The experimental set-up used in the below experiments is shown in FIG. 1. The meanings of the labels used therein are summarized together for a better overview.
(A) gas cylinder mounted in upside down direction
(B) corner valve
(C) HPLC pump
(D) valve
(E) pressure retaining valve
(F) three-way valve
(G) valve
(H) explosion-proof wall
(I) tube with a 8 mm Swagelok connection
(J) blast cap with RDX explosive
(K) metal foil (membrane)
(L) detonator
(M) shock absorber
(N) safety valve
(O) remote-controlled pneumatic valve
(P) off-gas pipe

The experiments were performed by either using a 2″ steel tube with an internal diameter of 2 inch (relating to 5.08 cm) and an inner length of about 40 cm, or a 4″ steel tube with an internal diameter of 4 inch (relating to 10.16 cm) and an inner length of about 50 cm. Such tubes are also often called GAP-tubes, but for the sake of simplicity only called tubes in the following. For each experiment, a blast cap (J) containing 160 g RDX/wax (95/5 w/w) together with a detonator (L) was mounted to the tube (I) and separated from the nitrous oxide sample space by a metal foil (K). RDX is a commonly used explosive, also known as hexogen, or chemically as 1,3,5-trinitroperhydro-1,3,5-triazine. According to the recommendations of the UN-GAP testing manual, hollow glass microspheres with a diameter of ca. 50 μm were added to simulate cavitation. In the case of the 2″ tube 0.25 g of the microspheres were added, while in the 4″ tube 2.1 g of microspheres were used. The top of the tube was closed with a threaded closure containing an inlet pipe and an outlet pipe, and a removable cooling coil mounted around the tube (not shown in FIG. 1). The bottom side of the tube prepared in this way was then put into a wood block as a shock absorber (M). The above-described set-up was located in an explosion-proof bunker and separated from the dosing equipment by an explosion-proof wall (H).

Before filling in the respective nitrous oxide sample, the system was purged free of air by passing pure gaseous nitrous oxide through it. After the purging, the tube (I) was cooled down by circulating a cooling liquid through the mounted cooling coil, and the test sample filled in. In case of pure nitrous oxide, nitrous oxide 5.0 with a nitrous oxide concentration of 99.999% was used. For the experiments with a nitrous oxide/carbon dioxide mixture, a premixed nitrous oxide/carbon dioxide mixture was used. Mixtures with ammonia or cyclopentene were prepared by separately adding nitrous oxide and ammonia or cyclopentene, respectively. The same principally applied for mixtures of nitrous oxide and nitrogen with the difference that nitrogen was added as a gas to a predetermined final pressure. The amount filled in was determined by weighing.

Once the tube (I) was filled with the respective test sample and cooled down to a set temperature of 247 K±2 K (−26.15° C.±2° C.), the blast cap (J) was brought to detonation by the detonator (L). Depending on the severity of the demolition, the experimental result was either classified as negative (non-explosive) or positive (explosive). A test was classified “positive” if the tube was fragmented into shrapnel, and “negative” if the tube was at the most only ruptured but stayed mostly in one piece.

Control Experiment with Water

As a control experiment for a negative test result, a 4″ tube was filled with water at room temperature and the blast cap (J) brought to detonation. The tube was only deformed.

### Example 1 (Comparative)

A 2″ tube containing 0.25 wt.-% of hollow glass microspheres was filled with 400 g of pure nitrous oxide and cooled down to the above-mentioned set temperature of 247 K±2 K (−26.15° C.±2° C.). At this temperature, nitrous oxide has a density of 1025 kg/m³. The blast cap (J) was then brought to detonation and the tube was ruptured only to a length of ca. 20 cm. No shrapnel was formed. The test was classified as “negative”. A tabular overview including a comparison with the other examples is given in table 1.

Example 1 confirmed that even pure, liquid nitrous oxide in a 2″ tube at a temperature of 247 K±2 K (−26.15° C.±2° C.) having a density of 1025 kg/m³ is not detonation sensitive to a shock wave.

### Example 2 (Comparative)

As pure nitrous oxide in a 2″ tube at 247 K±2 K (−26.15° C.±2° C.) is not detonation sensitive to a shock wave, pure nitrous oxide was tested under the same set temperature in a 4″ tube containing 2.1 wt.-% of hollow glass microspheres. The 4″ tube was filled with 3650 g pure nitrous oxide and cooled down to the above-mentioned set temperature of 247 K±2 K (−26.15° C.±2° C.). The blast cap (J) was then brought to detonation and the tube was fully ruptured forming shrapnel. The test was classified as “positive”. A tabular overview including a comparison with the other examples is given in table 1.

In contrast to the experimental set-up with a 2″ tube, pure nitrous oxide in a 4″ tube at a temperature of 247 K±2 K (−26.15° C.±2° C.) is detonation sensitive to a shock wave.

### Example 3 (Inventive)

As pure nitrous oxide in a 4″ tube at 247 K±2 K (−26.15° C.±2° C.) is detonation sensitive to a shock wave, it was tested whether a low content of nitrogen in nitrous oxide would prevent triggering a detonation by a shock wave. Therefore, a 4″ tube containing 2.1 wt.-% of hollow glass microspheres was filled with 4215 g of pure nitrous oxide and then pressurized with nitrogen to a pressure of 30.1 bar abs. The composition thus obtained contained 97.8 wt.-% nitrous oxide and 2.2 wt.-% nitrogen in the liquid phase. The composition was cooled down to the above-mentioned set temperature of 247 K±2 K (−26.15° C.±2° C.) and the blast cap (J) brought to detonation. The tube was ruptured to a length of ca. 13 cm. No shrapnel was formed. The test was classified as “negative”. A tabular overview including a comparison with the other examples is given in table 1.

Example 3 shows that even a content of only 2.2 wt.-% nitrogen in nitrous oxide is already sufficient to suppress the detonation sensitivity to a shock wave in a 4″ tube.

### Example 4 (Inventive)

As nitrogen was confirmed to be able to suppress the detonation sensitivity of nitrous oxide to a shock wave, it was tested whether also carbon dioxide is able to suppress the detonation sensitivity. Therefore, a 4″ tube containing 2.1 wt.-% of hollow glass microspheres was used, but filled with 3341 g of pure nitrous oxide and 440 g of carbon dioxide. The composition thus obtained contained 88.4 wt.-% nitrous oxide and 11.6 wt.-% carbon dioxide. The composition was cooled down to the above-mentioned set temperature of 247 K±2 K (−26.15° C.±2° C.) and the blast cap (J) brought to detonation. The tube was only bulged and not ruptured. The test was classified as “negative”. A tabular overview including a comparison with the other examples is given in table 1.

Example 4 shows that a content of 11.6 wt.-% carbon dioxide in nitrous oxide suppresses the detonation sensitivity to a shock wave in a 4″ tube.

### Example 5 (Inventive)

Example 5 is based on example 4, but performed with a lower content of carbon dioxide. A 4″ tube containing 2.1 wt.-% of hollow glass microspheres was filled with 3350 g of pure nitrous oxide and 320 g of carbon dioxide. The composition thus obtained contained 91.3 wt.-% nitrous oxide and 8.7 wt.-% carbon dioxide. The composition was cooled down to the above-mentioned set temperature of 247 K±2 K (−26.15° C.±2° C.) and the blast cap (J) brought to detonation. The tube was only bulged and not ruptured. The test was classified as “negative”. A tabular overview including a comparison with the other examples is given in table 1.

Example 5 shows that also a content of 8.7 wt.-% carbon dioxide in nitrous oxide suppresses the detonation sensitivity to a shock wave in a 4″ tube.

### Example 6 (Inventive)

Example 6 is based on example 5, but performed with a lower content of carbon dioxide. A 4″ tube containing 2.1 wt.-% of hollow glass microspheres was filled with 3320 g of pure nitrous oxide and 220 g of carbon dioxide. The composition thus obtained contained 93.8 wt.-% nitrous oxide and 6.2 wt.-% carbon dioxide. The composition was cooled down to the above-mentioned set temperature of 247 K±2 K (−26.15° C.±2° C.) and the blast cap (J) brought to detonation. The tube was only bulged and not ruptured. The test was classified as “negative”. A tabular overview including a comparison with the other examples is given in table 1.

Example 6 shows that also a content of 6.2 wt.-% carbon dioxide in nitrous oxide suppresses the detonation sensitivity to a shock wave in a 4″ tube.

### Example 7 (Inventive)

Example 7 is based on example 6, but performed with an even lower content of carbon dioxide. A 4″ tube containing 2.1 wt.-% of hollow glass microspheres was filled with 3615 g of pure nitrous oxide and 110 g of carbon dioxide. The composition thus obtained contained 97.05 wt.-% nitrous oxide and 2.95 wt.-% carbon dioxide. The composition was cooled down to the above-mentioned set temperature of 247 K±2 K (−26.15° C.±2° C.) and the blast cap (J) brought to detonation. The tube was ruptured to a length of ca. 32 cm. The test was classified as “negative”. A tabular overview including a comparison with the other examples is given in table 1.

Example 7 shows that also a content of 2.95 wt.-% carbon dioxide in nitrous oxide suppresses the detonation sensitivity to a shock wave in a 4″ tube.

### Example 8 (Comparative)

As nitrogen and carbon dioxide are stable, inert molecules and as such not sensitive to oxidation, the behavior of ammonia as an oxidable molecule was tested in a mixture with nitrous oxide. For this test, a 2″ tube containing 0.25 wt.-% of hollow glass microspheres was filled with 456 g of pure nitrous oxide and 10 g of ammonia. The composition thus obtained contained 97.9 wt.-% nitrous oxide and 2.1 wt.-% ammonia. The composition was cooled down to the above-mentioned set temperature of 247 K±2 K (−26.15° C.±2° C.) and the blast cap (J) brought to detonation. The tube was ruptured to a length of ca. 22.5 cm. The test was classified as “negative”. A tabular overview including a comparison with the other examples is given in table 1.

Example 8 shows that 2.1 wt.-% ammonia in a 2″ tube is not detonation sensitive to a shock wave.

### Example 9 (Comparative)

Example 9 is based on example 8, but performed with a much higher concentration of ammonia. For this test, a 2″ tube containing 0.25 wt.-% of hollow glass microspheres was filled with 275 g of pure nitrous oxide and 180 g of ammonia. The composition thus obtained contained 60.4 wt.-% nitrous oxide and 39.6 wt.-% ammonia. The composition was cooled down to the above-mentioned set temperature of 247 K±2 K (−26.15° C.±2° C.) and the blast cap (J) brought to detonation. The tube was fully fragmented forming shrapnel. The test was classified as “positive”. A tabular overview including a comparison with the other examples is given in table 1.

Example 9 shows that a composition containing a significantly higher concentration of ammonia in nitrous oxide is, even in a 2″ tube, detonation sensitive to a shock wave.

### Example 10 (Comparative)

As a relatively low content of 2.1 wt.-% ammonia in nitrous oxide in a 2″ tube is not detonation sensitive to a shock wave, the detonation behavior of a similar mixture was tested in a 4″ tube. Therefore, a 4″ tube containing 2.1 wt.-% of hollow glass microspheres was filled with 3300 g of pure nitrous oxide and 80 g of ammonia. The composition thus obtained contained 97.6 wt.-% nitrous oxide and 2.4 wt.-% ammonia. The composition was cooled down to the above-mentioned set temperature of 247 K±2 K (−26.15° C.±2° C.) and the blast cap (J) brought to detonation. The tube was completely ruptured and the test classified as “positive”. A tabular overview including a comparison with the other examples is given in table 1.

Example 10 shows that 2.4 wt.-% ammonia in nitrous oxide does not suppress the detonation sensitivity to a shock wave in a 4″ tube.

### Example 11 (Comparative)

As 2.4 wt.-% ammonia in nitrous oxide is detonation sensitive to a shock wave in a 4″ tube, it was tested whether the additional presence of carbon dioxide as an inert compound is able to suppress the detonation sensitivity. Therefore, a 4″ tube containing 2.1 wt.-% of hollow glass microspheres was filled with 3500 g of pure nitrous oxide, 430 g of carbon dioxide and 90 g of ammonia. The composition thus obtained contained 87.1 wt.-% nitrous oxide, 10.7 wt.-% carbon dioxide and 2.2 wt.-% ammonia. The composition was cooled down to the above-mentioned set temperature of 247 K±2 K (−26.15° C.±2° C.) and the blast cap (J) brought to detonation. The tube was fully ruptured forming shrapnel. The test was classified as “positive”. A tabular overview including a comparison with the other examples is given in table 1.

Example 11 shows that even in the presence of 10.7 wt.-% carbon dioxide the nitrous oxide composition is detonation sensitive to a shock wave in a 4″ tube if 2.2 wt.-% ammonia are present.

### Example 12 (Comparative)

As a further oxidable molecule, cyclopentene was tested in a mixture with nitrous oxide regarding its influence on the detonation sensitive of the mixture to a shock wave. Therefore, a 4″ tube containing 2.1 wt.-% of hollow glass microspheres was filled with 940 g of pure nitrous oxide and 1654 g of cyclopentene. The composition thus obtained contained 36.2 wt.-% nitrous oxide and 63.8 wt.-% cyclopentene. The composition was cooled down to the above-mentioned set temperature of 247 K±2 K (−26.15° C.±2° C.) and the blast cap (J) brought to detonation. The tube was fully ruptured forming shrapnel. The test was classified as “positive”. A tabular overview including a comparison with the other examples is given in table 1.

Example 12 shows that 63.8 wt.-% cyclopentene in nitrous oxide does not suppress the detonation sensitivity to a shock wave in a 4″ tube.

TABLE 1
Examples 1 to 12 (set temperature 247 K ± 2 K)

| | | | relative | |
|---|---|---|---|---|
| Ex. | tube | filling | composition | test result |
| 1 (comp.) | 2″ | 400 g pure N₂O | 100 wt.-% N₂O | negative |
| 2 (comp.) | 4″ | 3650 g pure N₂O | 100 wt.-% N₂O | positive |
| 3 (inv.) | 4″ | 4215 g pure N₂O | 97.8 wt.-% N₂O | negative |
| | | pressurized with | 2.2 wt.-% N₂ | |
| | | N₂ to 30.1 bara | | |
| 4 (inv.) | 4″ | 3341 g pure N₂O | 88.4 wt.-% N₂O | negative |
| | | 440 g CO₂ | 11.6 wt.-% CO₂ | |
| 5 (inv.) | 4″ | 3350 g pure N₂O | 91.3 wt.-% N₂O | negative |
| | | 320 g CO₂ | 8.7 wt.-% CO₂ | |
| 6 (inv.) | 4″ | 3320 g pure N₂O | 93.8 wt.-% N₂O | negative |
| | | 220 g CO₂ | 6.2 wt.-% CO₂ | |
| 7 (inv.) | 4″ | 3615 g pure N₂O | 97.05 wt.-% N₂O | negative |
| | | 110 g CO₂ | 2.95 wt.-% CO₂ | |
| 8 (comp.) | 2″ | 456 g pure N₂O | 97.9 wt.-% N₂O | negative |
| | | 10 g NH₃ | 2.1 wt.-% NH₃ | |
| 9 (comp.) | 2″ | 275 g pure N₂O | 60.4 wt.-% N₂O | positive |
| | | 180 g NH₃ | 39.6 wt.-% NH₃ | |
| 10 (comp.) | 4″ | 3300 g pure N₂O | 97.6 wt.-% N₂O | positive |
| | | 80 g NH₃ | 2.4 wt.-% NH₃ | |
| 11 (comp.) | 4″ | 3500 g pure N₂O | 87.1 wt.-% N₂O | positive |
| | | 430 g CO₂ | 10.7 wt.-% CO₂ | |
| | | 90 g NH₃ | 2.2 wt.-% NH₃ | |
| 12 (comp.) | 4″ | 940 g pure N₂O | 36.2 wt.-% N₂O | positive |
| | | 1654 g cyclopentene | 63.8 wt.-% | |
| | | | cyclopentene | |

1.-15. (canceled)

16. A process for the explosion-proof storage of nitrous oxide in the liquid phase in a container comprising filling the container with nitrous oxide and an inert component selected from nitrogen, oxygen, carbon dioxide, water, argon, helium, krypton, xenon and mixtures thereof, and keeping it at a temperature of 190 to 273 K, wherein
(i) the container has in all three spatial directions an inner distance between two opposite interior walls of ≥10 cm,
(ii) the concentration of the inert components comprises 2 to 20 wt.-% in total, based on the nitrous oxide in the liquid phase, and
(iii) compounds selected from
gases having a flammable range with air at 293.15 K and 101.3 kPa abs,
liquids having a flash point of ≤366.15 K at 101.3 kPa abs, and
mixtures thereof
are kept at 0 to 2 wt.-% in total, based on the nitrous oxide in the liquid phase.

17. A process according to claim 16, wherein the container has in all three spatial directions an inner distance between two opposite interior walls of ≥15 cm.

18. A process according to claim 16, wherein the container has an inner volume of 500 L to 100 m³.

19. A process according to claim 16, wherein the concentration of the inert components comprises 2.1 to 15 wt.-% in total, based on the nitrous oxide in the liquid phase.

20. A process according to claim 16, wherein the inert component is selected from nitrogen, carbon dioxide and mixtures thereof.

21. A process according to claim 16, wherein the concentration of nitrous oxide in the liquid phase is 82 to 98 wt.-%.

22. A process according to claim 16, wherein the gases having a flammable range with air at 293.15 K and 101.3 kPa abs are selected from hydrogen, carbon monoxide, ammonia, methylamine, dimethylamine, trimethylamine, ethylamine, methane, ethane, propane, n-butane, 2-methylpropane, 2,2-dimethylpropane, ethene, propene, but-1-ene, but-2-ene, 2-methylprop-1-ene, acetylene, methylacetylene, 1-butine, chloromethane, bromomethane, chloroethane, vinyl chloride, dimethyl ether, methyl ethyl ether, methyl vinyl ether, formaldehyde, hydrogen sulfide, methyl mercaptan, mono phosphane, methyl phosphine, diborane and stibine.

23. A process according to claim 16, wherein the liquids having a flash point of ≤366.15 K at 101.3 kPa abs are selected from methyl ethyl amine, diethylamine, triethylamine, n-propylamine, di-n-propylamine, tri-n-propylamine, n-butylamine, di-n-butylamine, tri-n-butylamine, ethylenediamine, pyrrolidine, piperidine, n-pentane, 2-methylbutane, n-hexane, n-heptane, n-octane, n-nonane, n-decane, n-undecane, n-dodecane, cyclopentane, cyclohexane, 1,3-butadiene, 2-butine, 1-pentene, 2-pentene, 2-methylbut-1-ene, 2-methylbut-2-ene, 2-methyl-1,3-butadiene, 1-octene, cyclopentene, cyclopentadiene, cyclohexene, 1,4-cyclohexadiene, benzene, toluene, xylenes, ethylbenzene, furan, pyrrol, 1-chloropropane, 2-chloropropane, 1-chlorobutane, 2-chlorobutane, chlorobenzene, ethanol, 1-propanol, 2-propanol, 1-butanol, 2-butanol, 2-methyl-1-propanol, tert.-butanol, pentanols, diethyl ether, 2,3-dihydrofuran, 2,5-dihydrofuran, tetrahydrofuran, acetaldehyde, propionaldehyde, butyraldehyde, valeraldehyde, acetone, 2-butanone, 2-pentanone, 3-pentanone, crotonaldehyde, methyl formate, ethyl formate, propyl formate, methyl acetate, ethyl acetate, propyl acetate and methyl propionate.

24. A process according to claim 16, wherein
(iii) compounds selected from
gases having a flammable range with air at 293.15 K and 101.3 kPa abs,
liquids having a flash point of ≤366.15 K at 101.3 kPa abs, and
mixtures thereof
are kept at 0 to 1 wt.-% in total, based on the nitrous oxide in the liquid phase.

25. A process according to claim 16, wherein nitrogen oxides having a N to O ratio of ≤1 are kept at a concentration at which the amount of nitrogen present in these nitrogen oxides is 0 to 1000 wt.-ppm in total, based on the nitrous oxide in the liquid phase.

26. A process according to claim 16, wherein nitrogen monoxide and nitrogen dioxide are kept at a concentration at which the amount of nitrogen present in these nitrogen oxides is 0 to 1000 wt.-ppm in total, based on the nitrous oxide in the liquid phase.

27. A process according to claim 24, wherein the nitrogen oxides having a N to O ratio of ≤1 are kept at a concentration at which the amount of nitrogen present in these nitrogen oxides is 0 to 10 wt.-ppm in total, based on the nitrous oxide in the liquid phase.

28. A process according to claim 16, wherein the liquid phase in the container is kept at 223 to 263 K.

29. A process according to claim 16, wherein the nitrous oxide is stored for ≥1 hour.

30. A process according to claim 16, wherein the nitrous oxide is stored for ≥1 week.
